(19) United States
(12) Patent Application Publication
(10) Pub. No.: US 2008/0140518 A1
(43) Pub. Date: Jun. 12, 2008

(54) SYSTEM AND METHOD FOR ENHANCING THE ABSORPTION AND RETENTION OF ADVERTISING MATERIAL

(75) Inventor: Samuel Grosz, Toronto (CA)

Correspondence Address: BERESKIN AND PARR, 40 KING STREET WEST, BOX 401, TORONTO, ON, M5H 3Y2, omitted

(73) Assignee: CROSSROADS MEDIA CORPORATION, Toronto (CA)

(21) Appl. No.: 11/567,448

(22) Filed: Dec. 6, 2006

(51) Int. Cl. G06Q 30/00

(52) U.S. Cl. 705/14

(57) ABSTRACT

A system and method for enhancing the absorption and retention of advertising material includes a display structure configured to be located in a place having pedestrian traffic, a remote advertising server containing secondary advertising material related to the primary advertising material, and an interactive terminal situated in proximity to the display structure for eliciting user input and for presenting the secondary advertising material in response to the input. The interactive terminal and the advertising server are connected through a communications network. The method includes the steps of placing a display structure in a location having high pedestrian traffic, presenting primary advertising material to potential customers, eliciting input from the potential customers through an interactive terminal located near by, receiving input from the customers, generating secondary advertising material related to the primary advertising material in response to the user input, and providing the secondary advertising material to the potential customers.

### FIELD OF THE INVENTION

The present invention relates to methods and apparatus for displaying advertising material, and in particular, to systems for displaying advertising material in public and other places having high pedestrian traffic.

### BACKGROUND OF THE INVENTION

Billboards, posters, display cases, and similar displays have been used for many years to advertise products and services to potential consumers in places having high pedestrian traffic, such as walkways along roads. These displays typically include an advertiser's trademark or trade name, graphics conveying a message related to the product or service being advertised, and a tagline or slogan. Displays that are visually striking tend to be effective at attracting the attention of potential customers. However, such displays are not adapted to convey in depth or detailed information to potential customers. Also, since these displays are static, they are not suited to engaging the interest of potential customers for a long period of time. As a result, the absorption and retention rate of the advertising message tends to be low, in the case of these types of conventional displays.

More recently, large screen video displays have been utilized to provide video advertising in public spaces. Since the human eye is attracted to movement, video advertisements tend to be more effective than static advertisements in attracting and retaining the attention of potential consumers over a period of time. However, video displays typically generate advertisements that last for only a relatively short period of time, and like static displays, video displays are not well adapted to display in depth information about a product or service. In addition, neither form of advertising display is able to provide personalized information of interest to a specific potential customer.

Accordingly, there is a need for a system to communicate advertising material to potential customers in such a way as to enhance their absorption and retention of the advertising material.

### SUMMARY OF THE INVENTION

The present invention is directed to a system for displaying advertising material. The system comprises at least one display structure configured to be located in a place having pedestrian traffic, an advertising server remote from the display structure, and at least one interactive terminal in proximity to the display structure. The display structure includes a conspicuous visual display for presenting primary advertising material to potential consumers passing thereby.

The advertising server comprises a computer server having a database for storing secondary advertising material related to the primary advertising material, and a server network interface for connecting to a communications network.

The interactive terminal comprises a terminal network interface connected to the communications network, a user input module for receiving user input from potential customers, a computer processor for processing the user input and for retrieving the secondary advertising material from the advertising server through the terminal network interface, and a user output module for communicating output the secondary advertising material to the potential customers.

The display structure may be a dynamic display, such as a video monitor, an animated model or a live demonstration, and include a network interface for connecting to the communications network, and a display controller for controlling the network interface and the dynamic display.

The present invention is also directed to a method for enhancing the absorption and retention of advertising material, comprising the steps of: placing a display structure having a conspicuous visual display in a place having pedestrian traffic; presenting primary advertising material, by way of the display structure to potential customers; eliciting user input from the potential customers by way of an interactive terminal located in proximity to the display structure; receiving user input from the potential customers through the interactive terminal; generating secondary advertising material related to the primary advertising materials in response to the user input; and providing the secondary advertising material to the potential customers.

### BRIEF DESCRIPTION OF THE DRAWINGS

FIG. 1 is a schematic diagram illustrating an advertising display system made in accordance with an embodiment of the invention;

FIG. 2 is a block diagram of the components of an advertising display system made in accordance with the invention;

FIG. 3 is a block diagram of an interactive terminal; and

FIG. 4 is a flowchart of a method for enhancing the absorption and retention of advertising material in accordance with an embodiment of the invention.

### DETAILED DESCRIPTION OF THE INVENTION

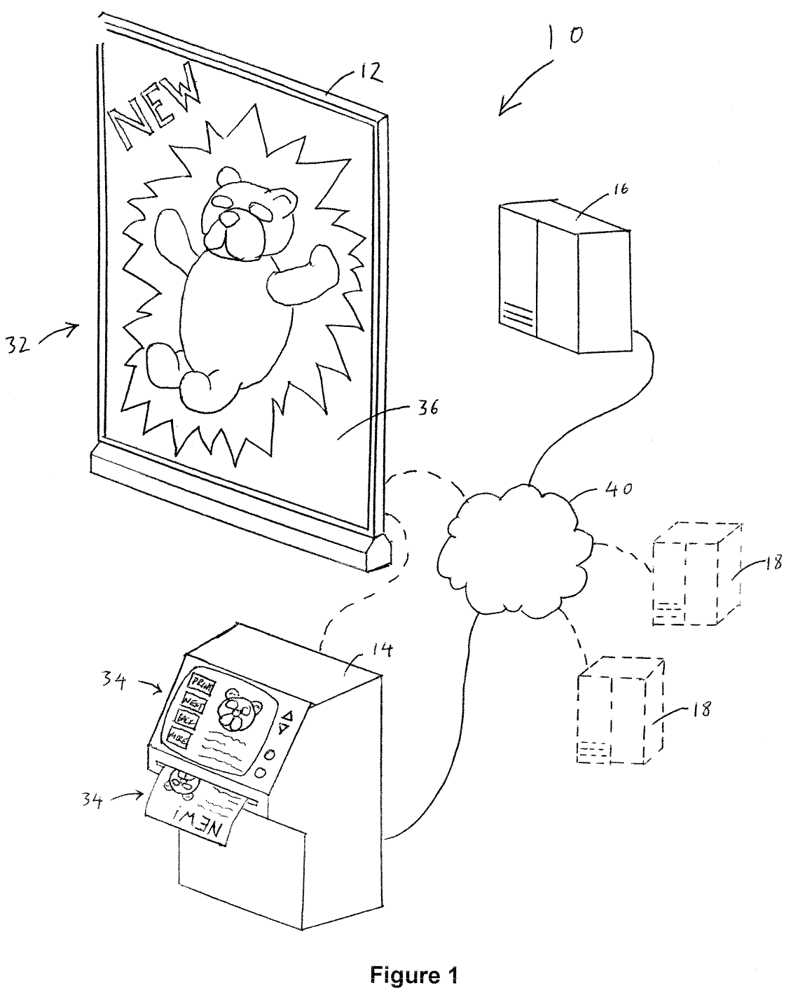

Referring to FIG. 1, illustrated therein is a system 10 for enhancing the absorption and retention of advertising information, made in accordance with an exemplary embodiment of the invention. System 10 comprises display structure 12 configured to be located in a place having pedestrian traffic, interactive terminal 14 proximate to display structure 12, and a remote advertising server 16.

Display structure 12 includes a visual display 36 for presenting primary advertising material 32 to potential customers passing thereby. The primary advertising material 32 is related to a vendor or brand of product or service, and typically includes the vendor's trade name and/or brand or trademark. Potential customers attracted by the primary advertising material 32 may interact with interactive terminal 14 to learn more about the goods or services advertised by display structure 12. Advertising server 16 distributes secondary advertising material 34 related to primary advertising material 32 to interactive terminals 14 as needed. In some embodiments, advertising server 16 obtains advertising material from supplier server 18 through a network 40 such as the Internet.

Visual display 36 is shaped to be visually conspicuous and to attract the attention of pedestrians passing by. Examples of suitable visual displays 36 include posters, billboards, scale models, display cases housing sample wares, and so on. Primary advertising material 32 delivers a marketing message regarding a vendor and/or one or more product or service. Primary advertising material 32 is typically designed to deliver only a single marketing message having high focus or cohesion in order to provide a strong impression on the viewer.

It should be understood that although visual display 36 is designed primarily to catch the eye, in some embodiments, visual display 36 may also have a subsidiary audio or other sensory component.

In the embodiment depicted in FIG. 1, display structure 12 comprises a visual display 36 such as a poster or sign sealed in a housing having an upright metal frame behind a transparent glass or plastic layer. The sign may be backlit for visibility in low light conditions. Typically, the metal frame is mounted to a wall at a height suitable for catching the eye, although it may also be free standing. The transparent layer may be hingedly connected to one side the metal frame, and have a lock on the other side such that the transparent layer may swing open to allow visual display 36 to be swapped out for newer material when needed. Preferably the transparent layer is made of a tough, resilient material such as plexiglass or polycarbonate to resist vandalism and for durability.

Alternatively, display structure 12 could comprise a visual display 36 in the form of a large, flat screen, video monitor such as a plasma display, which plays a repeating loop of video clip advertisements. An example of the subsidiary audio component mentioned above would be a soundtrack to match the video clip loop.

Another example of a display structure 12 is a display case for displaying samples of the advertised wares having a base and a transparent display case portion on top of the base. Spotlights may be positioned inside the display case to illuminate the displayed wares and show them to best advantage.

In some embodiments, advertising server 16 may also be connected to at least one supplier server 18. Supplier server 18 may also be a standard network server as previously described, and holds secondary advertising material 34 belonging to a particular supplier of goods or services referred to in primary advertising material 32. For example, advertising server 16 may be connected to one display structure 12 and terminal 14 pair where primary advertising material 32 refers to goods from a supplier A, and connected to another display structure 12 and terminal 14 pair where primary advertising material 32 refers to goods from a supplier B. Advertising server 16, in this case, may be connected through network 40 to a supplier server 18 operated by supplier A and to another supplier server 18 operated by supplier B.

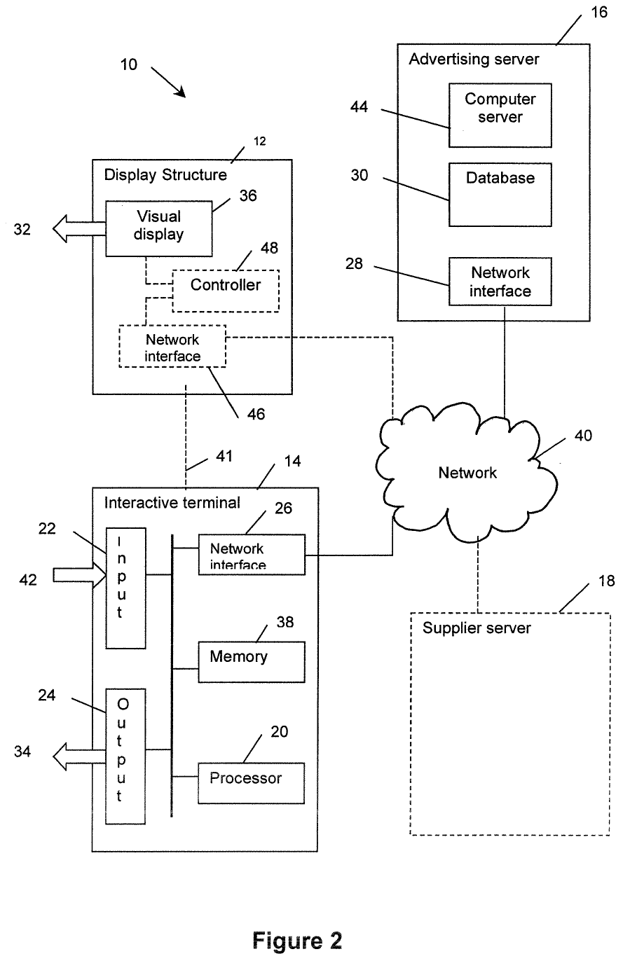

Referring now to FIG. 2, interactive terminal 14 is located in proximity to display structure 12. Interactive terminal 14 may be a standard interactive terminal having a main computer module comprising a processor 20, and a memory 38, connected to a network interface 26, a user input module 22, and a user output module 24. Interactive terminal 14 accepts input 42 from interested, potential customers for more information regarding the primary advertising material 32. Interactive terminal 14 responds to such requests by communicating secondary advertising material 34 related to primary advertising material 32 through user output module 24. For example, if primary advertising material 32 relates to a particular store, secondary advertising material 34 might relate to a catalog showing some items on sale at that store. Secondary advertising material 34 typically comprises more in depth information than primary advertising material 32, and may provide increased detail on the goods or services advertised.

Interactive terminal 14 is connected to communications network 40 through network interface 26 in order to communicate with advertising server 16. Communications network 40 is any standard communications network such as the Internet or circuit-switched telephony network and so on.

Advertising server 16 may be a standard network server comprising a computer server 44, a database 30 for holding secondary advertising material 34, and a server network interface 28 for connecting to communications network 40. Advertising server 16 communicates through network 40 to at least one interactive terminal 14 to provide secondary advertising material 34 to terminal 14. Secondary advertising material 34 may be provided to terminal 14 when terminal 14 requests it, or it may be pushed from advertising server 16 to terminal 14 on a scheduled basis. It should be understood that advertising server 16 may be implemented as a cluster of network servers having a single external interface.

In another embodiment, display structure 12 may further comprise a display controller 48 and a network interface 46 for connecting through communications network 40 to advertising server 16. In this embodiment, visual display 36 may be a dynamic display such as a video screen or animated model and so on requiring periodic updates to content or possible remote control. Display 36 is operated by display controller 48 which may receive updated primary advertising material 32 from advertising server 16. For example, if display 36 is a video screen, display controller 48 may receive new videos for display on the video screen. Similarly, if display 36 is an animated model, display controller 48 may receive new instructions for coordinating movement of the model with a new pre-recorded audio track and so on.

In addition, display structure 12 may also be in communication with terminal 14 either through network 40 or through a local communications link 41. Local communications link 41 could be any standard link suitable for electronic communication such as a serial cable, an Ethernet network, a wireless networking connection, radio frequency (RF) coaxial cable and so on.

In some embodiments, display structure 12 and terminal 14 may be in a master/slave relationship, with one of them controlling the other. For example, if display structure 12 were the master and terminal 14 were the slave, display controller 48 in display structure 12 may determine that it is time to obtain new primary and secondary advertising material from advertising server 16. Display controller 48 would request and then receive the new material from advertising server 16 and then provide the secondary advertising content to its slave, terminal 14. As another example, more than one terminal 14 may be associated with display structure 12, in which case secondary advertising material 34 may be cached at display structure 12 for distribution to more than one terminal 14.

Alternatively, if display structure 12 were the slave of terminal 14 instead, in the case where the choices available to a user of terminal 14 allow the selection of goods or services from a different supplier than is currently displayed, terminal 14 would command display structure 12 to display different primary advertising material 32. For example, if display structure 12 were currently displaying an advertisement for goods from supplier A, but during operation of terminal 14, the user requested to be shown goods from supplier B, terminal 14 could request new primary advertising material 32 from advertising server 16 to be transferred to display structure 12 and to be shown on display 32, as well as request new secondary advertising material 34 from advertising server 16 for use by terminal 14 itself.

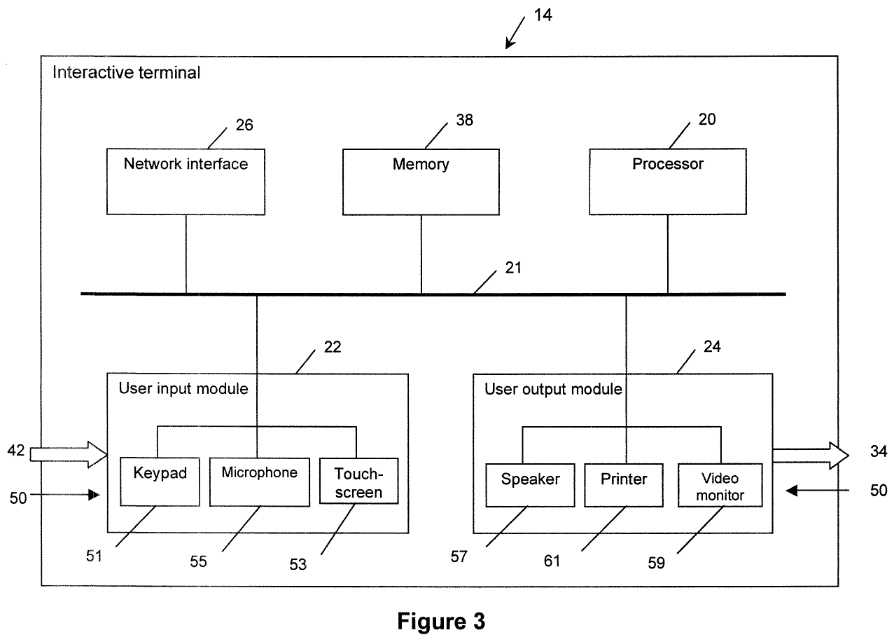

Referring now to FIG. 3, illustrated therein is a block diagram of interactive terminal 14 showing some of the possible elements of user input module 22 and user output module 24. It should be understood that these elements are exemplary and that other devices for provision of input or output to terminal 14 may instead be used.

User output module 24 communicates secondary advertising material 34 to a potential customer, for example through a video or audio presentation or through other formats which may be taken away from interactive terminal 14. User input module 22 serves to accept input 42 from a potential customer such as a request for further information.

Processor 20 is connected by a computer bus 21 to memory 38, which may further include both volatile and non-volatile storage. In addition, processor 20 is also operatively connected to user input module 22, user output module 24 and network interface 26. In some embodiments, network interface 26 may also be connected to memory 38. Similarly, user input module 22 and user output module 24, may also be connected to memory 38, especially if high bandwidth devices with heavy data transfer requirements such as video display screens are used. For convenience, FIGS. 2 and 3 depict a memory mapped computer in which the processor, memory, user input module and user output module all share the same bus but it should be understood that different computer architectures could be chosen. User input module 22 and user output module 24 may comprise a variety of input/output (I/O) devices, shown generally as 50.

Examples of I/O devices 50 used for input in user input module 22 may include a microphone 55, either singly or as part of a handset, buttons or a keypad 51, a touch-screen 53 and on-screen buttons or keypad, a video or still image camera, a joystick, a computer mouse, a touchpad or other pointing device and so on. Examples of I/O devices 50 used for output in user output module 24 may include a video display screen 59, audio speakers 57, a printer 61, or wireless communications means such as a Bluetooth or other wireless communications module. I/O devices 50 may be used singly or in any combination. Preferably a variety of I/O devices 50 are made available since providing output to the customer using different senses and different media will help to increase retention and absorption of the advertising material. That is, both hearing and seeing a video presentation will provide a stronger impression on the customer than sight or hearing alone could provide. This would also have the advantageous effect of facilitating accessibility.

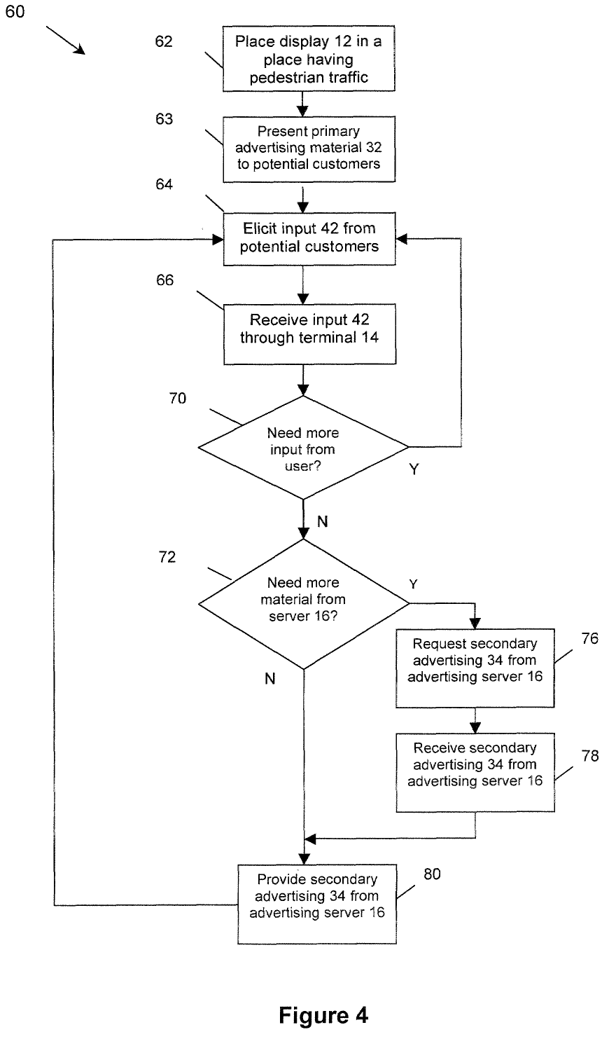

FIG. 4 illustrates a method 60 for enhancing the absorption and retention of advertising material, in accordance with an exemplary embodiment of the invention. In step 62, a display structure 12 is placed in a location having high pedestrian traffic, such as a sidewalk, or a walkway in an airport or mall. In step 63, display structure 12 presents primary advertising material 32 in a manner calculated to attract the attention of pedestrians passing by display structure 12.

In step 64, input is elicited from potential customers by way of an interactive terminal 14 located in proximity to display structure 12. This may be done through the mere presence of terminal 14, eye catching signage attached to terminal 14, an attract loop running on a video monitor 59 of terminal 14 and so on. Step 64 provides potential customers with the opportunity to request further, secondary advertising material 34 through the interactive terminal 14. One purpose of obtaining input and interaction from a potential customer is to prolong the length of time that the potential customer is in contact with advertising material related to a given product or service.

In step 66, system 10 receives input 42 from the customers by way of user input module 22 of interactive terminal 14.

In step 70, when further information is required before performing an action, a prompt is displayed for the user specifying what information is necessary. For example, in the case where a user has chosen to send information to a mobile phone, the user may be prompted for his telephone number. A variety of user input methods may be used to accept the information depending on what elements compose user input module 22 of terminal 14 (e.g., physical keypad, on-screen keypad, speech recognition etc.). After prompting the customer for more information, the method loops back to step 64 in order to elicit further user input.

Examples of such required customer information may be name, address, telephone number, e-mail address, credit information, personal identification number (PIN), geographical location, and so on. Another example of customer information might be demographic information used for example, if secondary advertising material contained data to make recommendations to a customer based on demographics.

In step 72, it is determined whether a response can be made immediately or whether more secondary advertising material 34 must be obtained from advertising server 16. If there is no need to obtain further advertising the appropriate response to the user input 42 is made in step 80.

Otherwise, the additional secondary advertising material 34 is requested in step 76 and is received in step 78, after which the relevant portion of secondary advertising material 34 is presented to the potential customer in step 80. In some embodiments of step 76, if the requested secondary advertising material 34 is not stored in database 30 of server 16 will in turn request secondary material 34 from a supplier server 18 to pass on to terminal 14 in step 78. Advertising server 16 may also give information regarding supplier server 18 to terminal 14 so that terminal 14 may request secondary material 34 directly.

The most common way that system 10 will respond to user input 42 is to communicate secondary advertising material 34 to the potential customer. Communicating secondary advertising material 34 could take many forms, all through user output module 24. For example, system 10 may communicate secondary advertising material 34 to a potential customer in a removable format such as a text-based information sheet from a printer 61 or an electronic file that is transferred to a user owned device such as a mobile phone or personal digital assistant. Alternatively, on-site formats of secondary advertising material 34 could be communicated by multimedia, audio-visual demonstrations through a video display screen 59 and audio speakers 57 of terminal 14. By thinking about what additional information to request, and by reviewing the secondary advertising material 34, the potential customer has participated actively in learning more about the primary advertising material and a deeper impression is created on him.

Other examples of responses to user input 42 may include going back to a previous view of secondary advertising material 34 or reacting to user requests to update settings or commands for terminal 14 to change state, for example by changing volume, brightness, the font size of displayed text, the sensitivity of a microphone, and other similar settings.

The main purpose of allowing user input 42 is to provide for interaction with secondary advertising material 34. For example, menu choices might be given to the customer allowing him to choose learning more about the history of the product, to see a list of popular uses, to hear quotes of reviews and so on.

System 10 relies on this interaction to attract and retain the attention of the customer as well as to increase the customers' absorption and retention of advertising information. This may be done by personalizing the information received by the customer or by choosing interesting menu choices paired with compelling information and content.

An example of personalization could take place in a terminal where one of the I/O devices 50 is a still image camera, and where the secondary advertisement material 34 relates to fashion. It is possible to take a picture of the customer's face using the still image camera and pair it with a variety of different fashion looks or hairstyles. This creates greater engagement in the customer than if only the clothing were shown.

Another example of interaction with advertising material increasing customer engagement and therefore absorption is a trial run of a product done on-screen. In situations where item selection is too great for user trials of physical inventory, it is possible to allow the user to perform the trial through terminal 14 instead of by handling a real product. For example, if secondary advertising material 34 related to books, it may be possible to read representative excerpts through terminal 14. Similarly, the user interfaces of various mobile phones might be tested on-screen on terminal 14 without needing to keep a large inventory of such phones on hand. Allowing a potential customer to try out or test a product increases the chance that he will remember it and increases his familiarity with it.

User interaction could also be applied to games or puzzles involving the product, or to allow a potential customer to see the results of product customization, such as different paint colour or wheel styles for automobiles.

In addition to outputs experienced on-site at terminal 14, in some embodiments, during step 80, secondary advertisement material 34 is presented to the customer in a removable format suitable for retention and later study. For instance, a brochure may be printed out through a printer device 61 of user output module 24. Other customers may prefer to have advertising information sent to their mobile phones through a short message (SMS), a multimedia message (MMS), an instant message (IM), through e-mail or any other format or small promotional items such as pens, keychains and other logo or trade-mark bearing items may also be provided to potential customers.

In another embodiment, a user may be able to purchase a product for delivery, to make an appointment to obtain a service, or even to obtain a service immediately, through terminal 14. For example, advisory or professional services might be obtained through a telephone-like handset connected to terminal 14. Terminal 14 would then create a voice link between the customer and a service provider, through advertising server 16 and supplier server 18.

To more clearly illustrate the functioning of the present invention, a sample interaction between system 10 and a potential customer is presented below.

A typical use might be to attract a pedestrian such as traveler having a long layover period between airplane flights, where display structure 12 and terminal 14 may be located in a corridor, a lounge of the airport, or some other highly trafficked location. When he walks by an advertising poster forming visual display 36 of display structure 12 in advertising display system 10, the traveler finds the graphics and tagline of the advertisement to be clever and interesting. In other words, his attention has been captured by step 62 of method 60. Normally, he would continue walking past display structure 12, however, he notices that there is a terminal 14 located near display structure 12 and that terminal 14 is showing on a video monitor an animation loop related to the ad, using the same imagery. A large button labeled “Press here for more” is displayed near the bottom of the video monitor. Terminal 14 is carrying out step 64, to elicit input.

The traveler, hereafter referred to as a potential customer, presses the large button displayed on video monitor 59. His input is read in step 66 by touch-screen 53 overlaying monitor 59, touch-screen 53 belonging to user input module 22 and monitor 59 belonging to user output module 24.

At this time, no further customer information or secondary advertising material 34 is yet required, so steps 70 and 72 are passed and in step 80, the attract loop is exited and a new screen is displayed on the monitor. In the main portion of the new screen, there is a large advertising graphic and a short welcome message. Along the left hand edge of the screen there are several buttons stacked vertically and labeled “News”, “Reviews”, “About the Company”, and “Contact Us”. These buttons represent menu choices. Along the right hand edge of the screen there are several buttons stacked vertically and labeled “Print”, “Download”, “E-mail”.

Now the system has returned to step 64 and waits for further input. The traveler touches “Reviews”, and steps 66, 70, 72 and 80 are again carried out.

In the main portion of the screen, there are now quotes from several reviewers and new menu choices “User Reviews”, “Professional Reviews”, and “Comparisons”.

In this exemplary embodiment of the invention, a toggle switch for changing font size is implemented using a toggle switch on the terminal. The toggle switch is labeled with a small capital letter A on one side and labeled with a large capital letter A on the other. If the potential customer were to activate the large side, in step 66 it would be determined that the user input represented a setting change which could be carried out immediately. Then in step 80, the screen would be redrawn to reflect the new, larger font size and method 60 would return to step 64 to await further input.

After exploring the secondary advertising material, the customer may decide to take away a printed brochure regarding the product, and therefore press the print button. In step 70 it is determined that system 10 does not yet have enough information to fulfill his request, so the customer is prompted to choose a product model in step 64. The system then returns to step 66 and waits for the user to select the desired model. Once that input is received, a detailed specification sheet for the customer is printed out in step 80.

During his interaction with advertising display system 10, the potential customer has spent a longer time in contact with the primary and secondary advertising materials than would have been the case for a simple print ad or television advertisement. In addition, he has himself chosen which elements of the secondary advertising material to explore, thereby increasing the chance that the information presented to him is relevant and of interest. During his time at the terminal, he as seen large scale graphics, read text, possibly heard music or voice and even smelled scents or felt surfaces, depending on the I/O devices 50 provided by user output module 24. In other words, the potential customer has employed more senses in more variety when taking in the advertising material than a billboard or terminal alone could provide. This more holistic experience of the advertising material should result in better retention of advertising material. Furthermore, he is able to take away a portion of the secondary advertising material, in this case in the form of a printed, detailed specification sheet, and will therefore increase his chance of being reminded of the product in the future.

It should be apparent to one skilled in the art that various modifications can be made to the embodiments disclosed herein, without departure from the invention, the scope of which is defined in the appended claims.

1. A system for displaying advertising material comprising:
a) at least one display structure configured to be located in a place having pedestrian traffic, the display structure including a conspicuous visual display for presenting primary advertising material to potential customers passing thereby;
b) an advertising server remote from the display structure, the advertising server comprising a computer server having a database for storing secondary advertising material related to the primary advertising material, and a server network interface for connecting to a communications network; and
c) at least one interactive terminal in proximity to the display structure, the interactive terminal comprising a terminal network interface connected to the communications network, a user input module for receiving user input from the potential customers, a computer processor for processing the user input and for retrieving the secondary advertising material from the advertising server through the terminal network interface, and a user output module for communicating the secondary advertising material to the potential customers.

2. The system of claim 1, wherein the visual display comprises a static display, the static display selected from a group including posters, billboards, scale models, and display cases housing sample wares.

3. The system of claim 1, wherein the visual display comprises a dynamic display, the dynamic display selected from a group including video monitors, animated models, and live demonstrations.

4. The system of claim 3, wherein the display structure further comprises a display network interface for connecting to the communications network for communication with the advertising server, and a display controller for controlling the network interface and the dynamic display.

5. The system of claim 1, wherein the advertising server is connected through the communications network to at least one supplier server.

6. The system of claim 1, wherein the user input module further comprises input devices selected from a group including buttons, keypads, touch-screens, cameras, joysticks, computer mice, touchpads and pointing devices.

7. The system of claim 1, wherein the user output module further comprises output devices selected from a group including video display screens, audio speakers, printers, and wireless communications means.

8. The system of claim 1, wherein the display structure and the interactive terminal are connected by a local communications link.

9. The system of claim 8, wherein the display structure and the interactive terminal are in a master/slave relationship, the interactive terminal being the master and the display structure being the slave.

10. A method for enhancing the absorption and retention of advertising, material, comprising the steps of:
a) placing a display structure having a conspicuous visual display in a place having pedestrian traffic;
b) presenting primary advertising material by way of the display structure to potential customers;
c) eliciting user input from the potential customers by way of an interactive terminal located in proximity to the display structure;
d) receiving user input from the potential customers through the interactive terminal;
e) generating secondary advertising material related to the primary advertising material in response to the user input; and
f) providing the secondary advertising material to the potential customers.

11. The method of claim 10, wherein step of generating the secondary advertising material comprises the step of retrieving the secondary advertising material from a remote advertising server through a communications network.

12. The method of claim 11, wherein the step of providing the secondary advertising material comprises printing the secondary advertising material on paper.

13. The method of claim 11, wherein the step of providing the secondary advertising material comprises displaying the secondary advertising material on a display screen of the interactive terminal.

14. The method of claim 11, wherein the step of responding to the user input comprises prompting the potential customers for purchase and delivery information.

15. The method of claim 10, wherein the step of eliciting input from the potential customers comprises adorning the terminal in eye catching dress.

16. The method of claim 10, wherein the step of eliciting input from the potential customers comprises playing an attract loop on a video monitor of the interactive terminal.

17. The method of claim 10, wherein the step of eliciting input from the potential customers comprises querying the customers for customer information.

18. The method of claim 10, wherein the step of presenting primary advertising material comprises retrieving the primary advertising material from a remote advertising server through a communications network.

19. The method of claim 18, wherein the steps of presenting primary advertising material comprises transferring the primary advertising material from the terminal to the display structure through a local communications link.

20. The method of claim 11, wherein the step of retrieving the secondary advertising material comprises transferring the secondary advertising material from a supplier server to the terminal through the communications network.
